(19) United States
(12) Patent Application Publication
(10) Pub. No.: US 2018/0234668 A1
(43) Pub. Date: Aug. 16, 2018

(54) Security Camera Device

(71) Applicant: Timothy Bauswell, Warren, MI (US)

(72) Inventor: Timothy Bauswell, Warren, MI (US)

(21) Appl. No.: 15/456,416

(22) Filed: Mar. 10, 2017

Related U.S. Application Data
(60) Provisional application No. 62/306,522, filed on Mar. 10, 2016.

(51) Int. Cl. H04N 7/18; H04N 5/232; G06K 9/00; G08B 13/196

(52) U.S. Cl. CPC H04N 7/186; H04N 5/232; G08B 13/19695; G08B 13/19628; G06K 9/00771

(57) ABSTRACT

A security camera device for viewing and recording still photographs and video and audio through a peep hole formed in a door is provided. The security camera device comprises a barrel having an inner surface with first threads and capable of being inserted into the peep hole. A camera surrounded by an outer surface is provided with the outer surface having second threads and the second threads of the camera threadably mountable to the first threads of the barrel. A motion detector detects motion on an exterior side of the door. A power source powers the camera and the motion detector. At least one monitor device communicates with the camera for displaying in real time and recording and storing still photographs and videos and sound captured by the camera. The camera is automatically activated by motion nearingly adjacent the exterior side of the door.

### CLAIM OF PRIORITY

This patent application claims priority under 35 USC 119 (e) (1) from U.S. Provisional Patent Application Ser. No. 62/306,522 filed Mar. 10, 2016, of common inventorship herewith entitled, “Peep Hole Cam,” which is incorporated herein by reference as though the same were set forth in its entirety.

### FIELD OF THE INVENTION

The present invention pertains to the field of residential safety, and more specifically to the field of security cameras providing a tiny digital camera particularly configured for installation into a peep hole of an exterior door.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

The prior art has put forth several designs for security cameras. Among these are:

US Patent Publication 2014/0267740 to Nedal Akram Almomani, Michael Maridakis and Greg Gluchowski describes an electronic lockset that allows for remote monitoring. The electronic lockset includes a locking mechanism, a motion sensor, a camera and a wireless communication module. The locking mechanism is moveable between a locked position and an unlocked position. The motion sensor is configured to detect a person in proximity to the electronic locket. The camera is configured to capture media content of the person detected by the motion sensor. The wireless communication module is configured to wirelessly transmit the captured media content to an electronic device.

U.S. Pat. No. 8,780,201 to Joseph Frank Scalisi, Andrew Paul Thomas, Gregory Saul Harrison and Desiree Mejia describes methods for using a doorbell that is configurable to wirelessly communicate with a remotely located computing device and includes obtaining a doorbell that comprises a speaker, a microphone, and a camera. Methods include entering a sleep mode in which the doorbell's wireless communication, the camera, and the microphone are disabled. Methods include exiting the sleep mode and entering a standby mode in response to the doorbell detecting a first indication of a visitor. The standby mode increases electrical activities of the doorbell's camera and microphone relative to the sleep mode. Methods include entering an alert mode in response to detecting a second indication of the visitor. The doorbell records an image using the camera during the alert mode. Wireless communication is enabled during the alert mode to send an alert to the remotely located computing device.

U.S. Pat. No. 8,487,998 to Shih-Che Chen describes a digital peephole viewer device which integrates with a door lens assembly on a door board to acquire optical images captured by the door lens assembly, converts the optical images into digital images, and then presents the digital images. The digital peephole viewer device of the present invention comprises a housing, an image capture component, a signal processing component, a display component and a connection means. The image capture component has a first lens to receive the optical images captured by the door lens assembly. The signal processing component converts the optical images into continuous dynamic digital images. The display component presents the continuous dynamic digital images. The connection means integrates the housing with the door lens assembly.

None of these prior art references describe the present invention.

### SUMMARY OF THE INVENTION

It is an object of the present invention to provide a tiny digital camera particularly configured for installation into a peep hole of an exterior door.

The present invention is a security camera device for viewing and recording still photographs and video and audio through a peep hole formed in a door. The door has an interior side and an exterior side. The security camera device comprises a barrel having an outer surface and an inner surface with the inner surface of the barrel having first threads and the barrel capable of being inserted into the peep hole. A camera surrounded by an outer surface is provided with the outer surface of the camera having second threads and the second threads of the camera threadably mountable to the first threads of the barrel. A motion detector detects motion on the exterior side of the door. A power source powers the camera and the motion detector. At least one monitor device communicates with the camera for displaying in real time and recording and storing still photographs and videos and sound captured by the camera. The camera is automatically activated by motion nearingly adjacent the exterior side of the door. Upon activation of the camera, the at least one monitor device displays, records, and stores information of activity on the exterior side of the door without risk associated with opening the door or approaching the door.

In addition, the present invention includes a method for viewing and recording still photographs and video and audio through a peep hole formed in a door. The door has an interior side and an exterior side. The method comprises providing a barrel having an outer surface and an inner surface, forming first threads on the inner surface of the barrel, inserting the barrel into the peep hole, providing a camera surrounded by an outer surface, forming second threads on the outer surface, threadably mounting the second threads of the camera to the first threads of the barrel, powering the camera, detecting motion on the exterior side of the door, automatically activating the camera by motion nearingly adjacent the exterior side of the door, providing at least one monitor device, communicating between the camera and the at least one monitor device, and displaying in real time and recording and storing still photographs and videos and sound captured by the camera.

The present invention further includes a security camera device for viewing and recording still photographs and video and audio through a peep hole formed in a door. The door has an interior side and an exterior side. The security camera device comprises a barrel having an outer surface and an inner surface with the inner surface of the barrel having first threads and the barrel capable of being inserted into the peep hole. A camera surrounded by an outer surface is provided with the outer surface of the camera having second threads and the second threads of the camera threadably mountable to the first threads of the barrel. A motion detector detects motion on the exterior side of the door with the motion detector is capable of being mounted within the peep hole. A power source powers the camera and the motion detector. At least one monitor device wirelessly communicates with the camera for displaying in real time and recording and storing still photographs and videos and sound captured by the camera. The camera is automatically activated by motion nearingly adjacent the exterior side of the door and upon activation of the camera, the at least one monitor device displays, records, and stores information of activity on the exterior side of the door without risk associated with opening the door or approaching the door.

### BRIEF DESCRIPTION OF THE DRAWINGS

FIG. 1 is a perspective view illustrating a security camera device, constructed in accordance with the present invention, showing a camera installed in a peep hole of an exterior door with an empty wall to the right of the door and a corresponding display monitor screen mounted on a wall to the left of the door.

FIG. 2 is a perspective view illustrating the security camera device, constructed in accordance with the present invention, with the camera installed in the peep hole of the door.

FIG. 3 is a perspective view illustrating the security camera device, constructed in accordance with the present invention, showing the camera installed in the peep hole of the door with the corresponding display monitor screen mounted on a wall the to the left of the door.

FIG. 4 is a perspective view illustrating the security camera device, constructed in accordance with the present invention, showing the display monitor screen mounted on the wall next to the door having the peep hole which contains the camera.

FIG. 5 is a perspective view illustrating the security camera device, constructed in accordance with the present invention, with the camera seatable within a barrel.

FIG. 6 is a perspective view illustrating the barrel of the security camera device, constructed in accordance with the present invention.

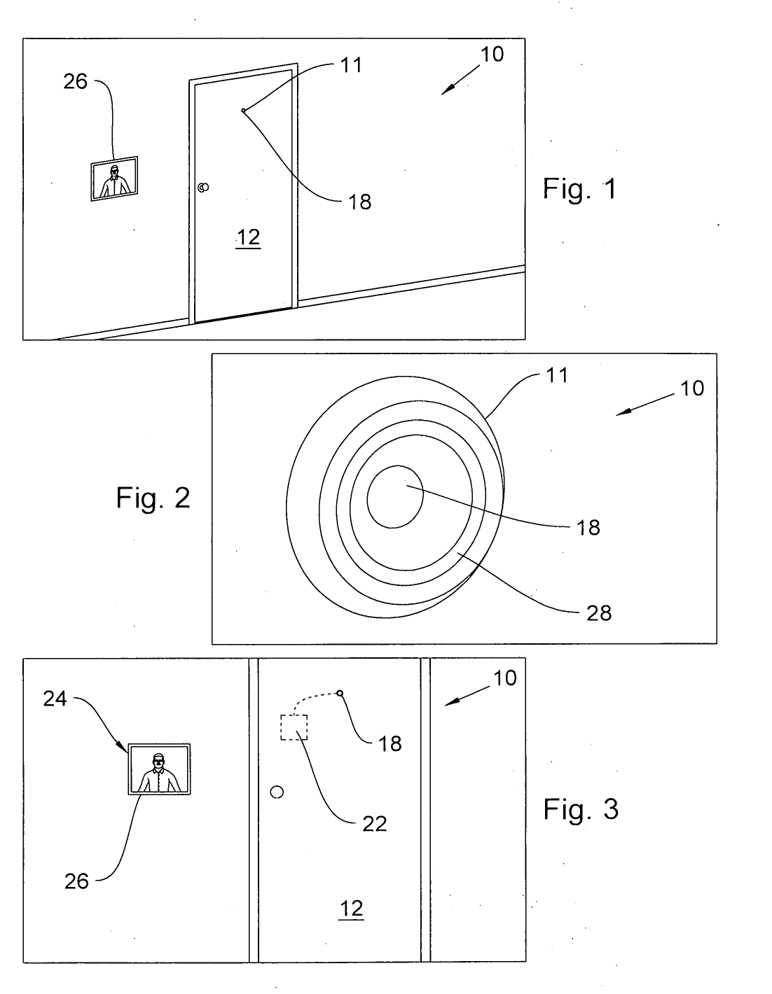

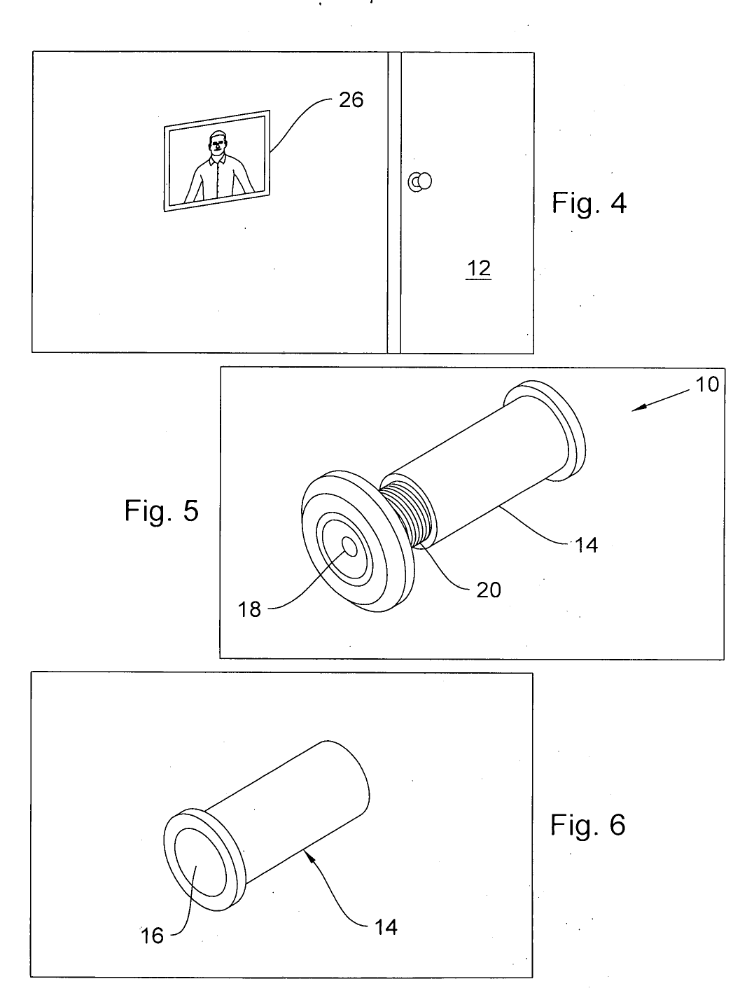

### DETAILED DESCRIPTION OF THE INVENTION

The present invention, hereinafter referred to as a Security Camera Device, indicated generally at 10, is a tiny digital camera particularly configured for installation in a peep hole 11 of an exterior or interior door 12. The peep hole 11 is a small opening through the door 12 allowing an individual to look from the inside to the outside. Typically, the peep hole 11 contains a door viewer releasably secured within the peep hole 11. The door viewer usually consists of a lens and a barrel 14. The lens is the part of the door viewer with lens threads on the outside. The barrel 14 is the part of the door viewer with the barrel threads 16 on the inside. The lens is inserted into the peep hole 11 from the exterior side of the door 12. Then, the barrel 14 is threadably inserted into the peep hole 11 from the interior side of the door 12 and threadably connected to the lens. The lens and barrel 14 are then tightened together thereby releasably securing the door viewer within the peep hole 11.

The Security Camera Device 10 of the present invention includes a camera 18. The camera 18 is preferably comprised of a 2.13 Megapixel camera 18 although any resolution camera for use as the camera 18 is within the scope of the present invention. The camera 18 is preferably has a threaded outer surface 20 or inserted. into a camera sleeve having a threaded outer surface. Once the lens of the door viewer is removed from the barrel 14, the camera 18 or camera sleeve threads neatly into a preexisting, threaded, cylindrical barrel 14 positioned within the peep hole 11, which is normally configured for holding a lens in the peep hole 11 of the exterior door or interior door 12. The Security Camera Device 10 actually replaces the lens of the door viewer in the peep hole 11 formed in the door 12.

The camera 18 of the Security Camera Device 10 of the present invention can be powered by a battery 22 or wiring into a structure's existing electrical system. Preferably, the camera 18 is powered by the battery to eliminate problems inherent in wiring a door. The battery 22 can be part of a compact, lightweight rechargeable battery pack 24 having a peel and stick adhesive backing for securing the battery pack 24 on the interior side of the door 12.

Activated by motion outside the doorway, the Security Camera Device 10 of the present invention displays and stores recorded images on a monitor device 26 having a separate screen and a separate microprocessor away from the door 12, such as a wall mounted LCD screen, a laptop, or a smartphone.

The camera 18 of the Security Camera Device 10 of the present invention is wirelessly linked by radio frequency technology to one or more monitor devices 26 capable of receiving its images and videos. As briefly mentioned above, the monitor device 26 that receives, displays, and stores the transmitted digital photos or video may be a separate standalone wall mounted monitor screen and microprocessor, a smartphone by means of a software application, or a computer such as a desktop, laptop, and/or tablet.

Preferably, the mounted monitor screen of the monitor device 26 of the Security Camera Device 10 of the present invention is mounted a predetermined distance away from the door 12 and at eye level of the inside occupant for easy viewing capability. An incorporated motion sensor 28 in the Security Camera Device 10 detects the presence of an individual outside the door 12 and automatically activates the camera 18. The screen monitor of the monitor device 26 is audibly and visually activated on the resident's wall, smartphone, tablet, and/or computer, thus alerting an inside occupant to the presence of a person outside. The inside occupant can have a good look at the individual from a safe distance, and from behind a locked door 12, to determine whether it is safe to open the door 12.

The Security Camera Device 10 of the present invention enables residential and business occupants to know who is at the door 12 without placing themselves at risk by opening the door 12 or even approaching the door 12. The Security Camera Device 10 retains an advantage of a having a peep hole 11 in one's door 12 while eliminating a disadvantage of a peep hole 11 with only look thorough capability, which is being heard when walking to a door 12 and checking who is at the door 12 by eyeballing a visitor through the peep hole 11. Further, the Security Camera Device 10 not only takes digital photos and/or video, but also stores the digital photos and/or video. Using the Security Camera Device 10 also provides law enforcement with photographic evidence and identification of potential perpetrators or intruders. Easily installed and operated, the Security Camera Device 10 activates automatically in response to anyone approaching the exterior door 12 from outside. Durably constructed of high quality materials and components, the Security Camera Device 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A security camera device for viewing and recording still photographs and video and audio through a peep hole formed in a door, the door having an interior side and an exterior side, the security camera device comprising:
a barrel having an outer surface and an inner surface, the inner surface of the barrel having first threads, the barrel capable of being inserted into the peep hole
a camera surrounded by an outer surface, the outer surface of the camera having second threads, the second threads of the camera threadably mountable to the first threads of the barrel;
a motion detector for detecting motion on the exterior side of the door;
a power source for powering the camera and the motion detector; and
at least one monitor device communicating with the camera for displaying in real time and recording and storing still photographs and videos and sound captured by the camera;
wherein the camera is automatically activated by motion nearingly adjacent the exterior side of the door; and
wherein upon activation of the camera, the at least one monitor device displays, records, and stores information of activity on the exterior side of the door without risk associated with opening the door or approaching the door.

2. The security camera device of claim 1 wherein the camera has a camera sleeve, the camera sleeve having the outer surface threaded with the second threads, the camera positionable within the camera sleeve.

3. The security camera device of claim 1 wherein the power source is at least one battery.

4. The security camera device of claim 3 and further comprising:
a rechargeable battery pack containing the at least one battery.

5. The security camera device of claim 4 wherein the rechargeable battery pack has a peel and stick adhesive backing.

6. The security camera device of claim 1 wherein the camera is wirelessly linked by radio frequency to the at least one monitor device.

7. The security camera device of claim 1 wherein the at least one monitor device is selected from the group consisting of a wall mounted LCD screen, a laptop, and a smartphone.

8. The security camera device of claim 7 wherein still photographs and videos captured by the camera are recorded on two or more monitor devices.

9. The security camera device of claim 8 wherein the camera is wirelessly linked by radio frequency to each of the monitor devices.

10. The security camera device of claim 7 wherein the mounted LCD screen is mounted a predetermined distance away from the door and at a predetermined height.

11. The security camera device of claim 1 wherein the motion detector is capable of being mounted within the peep hole.

12. A method for viewing and recording still photographs and video and audio through a peep hole formed in a door, the door having an interior side and an exterior side, the method comprising:
providing a barrel having an outer surface and an inner surface;
forming first threads on the inner surface of the barrel;
inserting the barrel into the peep hole;
providing a camera surrounded by an outer surface;
forming second threads on the outer surface;
threadably mounting the second threads of the camera to the first threads of the barrel;
powering the camera;
detecting motion on the exterior side of the door;
automatically activating the camera by motion nearingly adjacent the exterior side of the door;
providing at least one monitor device;
communicating between the camera and the at least one monitor device; and
displaying in real time and recording and storing still photographs and videos and sound captured by the camera.

13. A security camera device for viewing and recording still photographs and video and audio through a peep hole formed in a door, the door having an interior side and an exterior side, the security camera device comprising:
a barrel having an outer surface and an inner surface, the inner surface of the barrel having first threads, the barrel capable of being inserted into the peep hole;
a camera surrounded by an outer surface, the outer surface of the camera having second threads, the second threads of the camera threadably mountable to the first threads of the barrel;
a motion detector for detecting motion on the exterior side of the door, the motion detector is capable of being mounted within the peep hole;
a power source for powering the camera and the motion detector; and
at least one monitor device wirelessly communicating with the camera for displaying in real time and recording and storing still photographs and videos and sound captured by the camera;
wherein the camera is automatically activated by motion nearingly adjacent the exterior side of the door; and
wherein upon activation of the camera, the at least one monitor device displays, records, and stores information of activity on the exterior side of the door without risk associated with opening the door or approaching the door.

14. The security camera device of claim 13 wherein the camera has a camera sleeve, the camera sleeve having the outer surface threaded with the second threads, the camera positionable within the camera sleeve.

15. The security camera device of claim 13 wherein the power source is at least one battery.

16. The security camera device of claim 15 and further comprising:
a rechargeable battery pack containing the at least one battery.

17. The security camera device of claim 16 wherein the rechargeable battery pack has a peel and stick adhesive backing.

18. The security camera device of claim 13 wherein the at least one monitor device is selected from the group consisting of a wall mounted LCD screen, a laptop, and a smartphone.

19. The security camera device of claim 18 wherein still photographs and videos captured by the camera are recorded on two or more monitor devices.

20. The security camera device of claim 19 wherein the camera is wirelessly linked to each of the monitor devices.
